(19) United States
(12) Patent Application Publication
(10) Pub. No.: US 2019/0040536 A1
(43) Pub. Date: Feb. 7, 2019

(54) METHOD FOR MANUFACTURING PHOTOSEMICONDUCTOR, PHOTOSEMICONDUCTOR AND HYDROGEN PRODUCTION DEVICE

(71) Applicant: Panasonic Intellectual Property Management Co., Ltd., Osaka (JP)

(72) Inventors: HIDEAKI MURASE, Osaka (JP); MISA YOROZUYA, Osaka (JP)

(21) Appl. No.: 16/044,416

(22) Filed: Jul. 24, 2018

(30) Foreign Application Priority Data
Aug. 3, 2017 (JP) 2017-150795

(51) Int. Cl. C25B 1/00; C01B 21/06; B01J 19/08; C25B 1/04; C25B 11/04; H01G 9/20

(52) U.S. Cl. CPC C25B 1/003; C01B 21/0625; C01B 21/0615; B01J 19/088; B01J 2219/0841; C25B 11/0447; H01G 9/20; B01J 2219/0896; B01J 2219/0879; C25B 1/04

(57) ABSTRACT

The method for manufacturing a photosemiconductor according to the present disclosure includes treating a metal base material containing at least one kind of transition metal with a plasma under a pressure lower than atmospheric pressure and at a temperature lower than a volatilization temperature of the transition metal under an atmosphere at the pressure to provide the photosemiconductor containing the transition metal and a nitrogen element from at least a part of the metal base material. Here, the plasma is generated by applying a high-frequency voltage at a frequency in a range of not less than 30 MHz and not more than 300 MHz to a gas between a first electrode and a second electrode, and the gas is any one of: (i) a nitrogen gas; (ii) a gaseous mixture consisting of a nitrogen gas and an oxygen gas; (iii) a gaseous mixture consisting of a nitrogen gas and a rare gas; and (iv) a gaseous mixture consisting of a nitrogen gas, an oxygen gas, and a rare gas.

### BACKGROUND

### 1. Technical Field

The present disclosure relates to a method for manufacturing a photosemiconductor, a photosemiconductor and a hydrogen production device.

### 2. Description of the Related Art

When a photosemiconductor is irradiated with light, electron-hole pairs are generated in the photosemiconductor. Photosemiconductors can be applied to uses such as light emitting diodes (LEDs) and lasers which extract light generated in recombination of the electron-hole pairs; solar cells which spatially separate the pairs to extract photovoltaic power as electric energy; and photocatalysts which produce hydrogen directly from water and sunlight. Thus, photosemiconductors are promising. A group of photosemiconductors that absorb or release light in an ultraviolet-to-visible light range include oxides, oxynitrides and nitrides. Particularly, as photosemiconductors for use in photocatalysts, typically titanium oxide (TiO₂) and zinc oxide (ZnO) have been used. A conventional semiconductor electrode including such a photosemiconductor has a problem of low hydrogen generation efficiency in a water-splitting reaction by irradiation of sunlight. This is because a semiconductor material such as TiO₂ can absorb only light having a short wavelength, generally a wavelength of not more than 400 nanometers, and in the case of TiO₂, a ratio of utilizable light to total sunlight is very low, i.e. about 4.7%. Further, considering a loss from a theoretical thermal loss, utilization efficiency of the sunlight is about 1.7% with respect to the absorbed light.

Thus, a photosemiconductor material capable of increasing a ratio of utilizable light to total sunlight, i.e. a photosemiconductor material capable of absorbing light in a visible light range, which has a longer wavelength, in order to improve hydrogen generation efficiency in a water-splitting reaction by irradiation of sunlight, is desired.

In response to this demand, a photosemiconductor material intended to improve utilization efficiency of sunlight by absorbing visible light having a longer wavelength has been suggested. For example, PTL 1 discloses a photocatalyst composed of a tantalum nitride represented by compositional formula: Ta₃N₅, as a semiconductor material capable of absorbing visible light. According to PTL 1, the tantalum nitride is capable of absorbing light having a wavelength of not more than 600 nanometers.

### CITATION LIST

### Patent Literature

PTL 1: Japanese Patent Publication No. 4064065

### Non-Patent Literatures

NPL 1: Moussab Harb et. al., “Tuning the properties of visible-light-responsive tantalum (oxy)nitride photocatalysts by nonstoichiometric compositions: a first-principles viewpoint”, Physical Chemistry Chemical Physics, 2014, Volume 16, Issue 38, 20548-20560

NPL 2: Roger Marchand et. al., “Nitrides and oxynitrides: Preparation, crystal chemistry and properties”, Journal of the European Ceramic Society, Volume 8, Issue 4 (1991), Pages 197-213

NPL 3: Francis J DiSalvo et. al. “Ternary nitrides: a rapidly growing class of new materials” Current Opinion in Solid State & Materials Science 1996, 1, 241-249

NPL 4: Foundation and Application of Atmospheric Pressure Plasma (2009) 164-168

NPL 5: Kosuke Matsuzaki et. al., “Controlled bipolar doping in Cu3N (100) thin films”, Applied Physics Letters, 105, 222102 (2014)

### SUMMARY

One non-limiting and exemplary embodiment provides a method for manufacturing a photosemiconductor, the method being capable of manufacturing a photosemiconductor containing a transition metal and a nitrogen element more safely and conveniently with a higher throughput as compared to a conventional manufacturing method.

In one general aspect, the techniques disclosed here feature a method for manufacturing a photosemiconductor, the method including treating a metal base material containing at least one kind of transition metal with a plasma under a pressure lower than atmospheric pressure and at a temperature lower than a volatilization temperature of the transition metal under an atmosphere at the pressure to provide the photosemiconductor containing the transition metal and a nitrogen element from at least a part of the metal base material,

wherein the plasma is generated by applying a high-frequency voltage at a frequency in a range of not less than 30 MHz and not more than 300 MHz to a gas between a first electrode and a second electrode, and

the gas is any one of:

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

With the manufacturing method of the present disclosure, a photosemiconductor containing a transition metal and a nitrogen element can be manufactured safely and conveniently with a high throughput.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

It should be noted that general or specific embodiments may be implemented as a system, a method, an integrated circuit, a computer program, a storage medium, or any selective combination thereof.

### BRIEF DESCRIPTION OF THE DRAWINGS

FIG. 1 is a schematic view showing an example of a configuration of a plasma generating apparatus to be used in a method for manufacturing a photosemiconductor according to one exemplary embodiment of the present disclosure.

FIG. 2 is a sectional view showing a metal base material before plasma treatment in one step included in the method for manufacturing a photosemiconductor according to one exemplary embodiment of the present disclosure.

FIG. 3 is a sectional view showing a photosemiconductor formed by a plasma treatment in one step included in the method for manufacturing a photosemiconductor according to one exemplary embodiment of the present disclosure.

FIG. 4 is a schematic view showing one example of a configuration of a hydrogen production device according to one exemplary embodiment of the present disclosure.

FIG. 5A shows results of X-ray diffraction for a photosemiconductor obtained in Inventive example 1 of the present disclosure.

FIG. 5B shows results of ultraviolet/visible diffusion reflection measurement of the photosemiconductor obtained in Inventive example 1 of the present disclosure.

FIG. 6A shows results of X-ray diffraction for a photosemiconductor obtained in each of Inventive examples 2 and 3 of the present disclosure.

FIG. 6B shows results of ultraviolet/visible diffusion reflection measurement of the photosemiconductor obtained in each of Inventive examples 2 and 3 of the present disclosure.

### DETAILED DESCRIPTION OF THE EMBODIMENTS

For increasing a ratio of utilizable light to total sunlight in order to improve hydrogen generation efficiency in a water-splitting reaction as described above, use of a nitride photosemiconductor is one solution. Specifically, a valence band in the nitride photosemiconductor is constituted by an N2p orbit level, and the N2p orbit level is closer to an oxidized level of water than to an O2p orbit. In other words, the valence band in the nitride photosemiconductor is positioned at a higher energy level as compared to a valence band constituted by an O2p orbit in an oxide photosemiconductor. Thus, the nitride photosemiconductor is capable of narrowing a width of a band gap, i.e. widening a wavelength range over which a reaction with light takes place, so that a photocurrent value can be increased.

The nitride photosemiconductor is manufactured by use of, for example, a metal oxide as a starting material. As a conventional method for manufacturing a nitride by use of a metal oxide as a starting material, a reduction nitriding synthesis reaction using an ammonia gas is generally employed (see NPL 1).

However, the conventional method for manufacturing a nitride photosemiconductor from a metal oxide by a reduction nitriding synthesis reaction using an ammonia gas has a problem in complexity, throughput and safety.

### Circumstances Leading to Attainment of One Aspect According to the Present Disclosure

A photosemiconductor capable of improving hydrogen generation efficiency in a water-splitting reaction, and increasing a ratio of utilizable light to total sunlight may be a nitride photosemiconductor. Specifically, a valence band in the nitride photosemiconductor is constituted by an N2p orbit level, and the N2p orbit level is closer to an oxidized level of water than to an O2p orbit. In other words, the valence band in the nitride photosemiconductor is positioned at a higher energy level as compared to a valence band constituted by an O2p orbit in an oxide photosemiconductor. Thus, the nitride photosemiconductor is capable of narrowing a width of a band gap, i.e. widening a wavelength range over which a reaction with light takes place, so that a photocurrent value can be increased.

The nitride photosemiconductor is manufactured by use of, for example, a metal oxide as a starting material. As a conventional method for manufacturing a nitride by use of a metal oxide as a starting material, a reduction nitriding synthesis reaction using an ammonia gas is generally employed (See NPL 1). In the reduction nitriding synthesis reaction, ammonia is supplied to a metal oxide as a starting material at a high temperature, and nitrogen replaces oxygen in the metal oxide, so that the reaction proceeds. This reaction is generally called an ammonia gas reduction nitriding method, or an ammonolysis reaction. For example, a reaction formula for synthesis of a nitride (Ta₃N₅) of pentavalent tantalum is as shown in formula (A) below.

3Ta₂O₅+10NH₃→2Ta₃N₅+15H₂O↑(A)

Specifically, when a metal oxide is used, a reaction process in the ammonia gas reduction nitriding method represented by formula (A) involves a reduction reaction in which hydrogen in active species such as NH₂ and NH generated by thermal decomposition in the reaction process reacts with oxygen in the metal oxide to be desorbed as water vapor, and a nitriding reaction in which nitrogen atoms are introduced in the metal oxide. However, formula (A) represents merely an ideal reaction, and in a real reaction process, a competitive reaction as shown below takes place, so that reaction efficiency is inevitably reduced.

NH₃→1/2N₂+3/2H₂ (B)

2Ta₃N₅+15H₂O→3Ta₂O₅+10NH₃ (C)

Specifically, the reaction may be described as follows. As shown in formula (B), generally ammonia (NH₃) is thermally decomposed into nitrogen (N₂) and hydrogen (H₂) at not lower than 500 degrees Celsius. A nitrogen molecule forms a triple bond, and binding energy of the triple bond is 941 kJ/mol, which is much larger than, for example, binding energy (500 kJ/mol) of an oxygen molecule that forms a double bond. In other words, the nitrogen molecule is very stable, high activation energy is therefore required for a direct reaction between nitrogen and a metal oxide, and the reaction is normally difficult to proceed under an equilibrium condition. NPL 2 suggests that the reduction nitriding reaction of a gaseous mixture of nitrogen and hydrogen prevents a reaction from efficiently proceeding. NPL 3 suggests that free energy of formation of an oxide is relatively stable in comparison with free energy of formation of a nitride, and under a high temperature at which an ammonia gas reduction nitriding method is applied, an oxidation reaction with water vapor secondarily produced as in formula (C) proceeds again, so that reaction efficiency is reduced.

In a normal ammonia gas reduction nitriding method, secondarily produced water vapor is quickly removed, and a large amount of an ammonia gas is supplied for promoting a reaction at a surface of a metal oxide (starting material) in order to avoid reduction of reaction efficiency as described above. Specifically, generally retention time τ of a gas in a chamber satisfies a relationship of τ=PV/Q (P: pressure, V: chamber volume, Q: gas flow rate), and therefore when a large amount of an ammonia gas is fed, the retention time of all gases including water vapor decreases, so that fresh ammonia that is not thermally decomposed is supplied to a thin film surface to improve reaction efficiency. However, since the reaction requires a long time, a large amount of ammonia is required to be continuously supplied during the reaction, and installation of a damage elimination apparatus, etc. is thus necessary, so that the reaction system is very complicated, and has very poor economic efficiency. Ammonia is a Group-3 specified chemical substance, and has a problem in safety in mass production. As described above, a temperature in synthesis is relatively high, i.e. not lower than a thermal decomposition temperature (500 degrees Celsius) of ammonia, leading to a temporal constraint in a temperature rising and falling process. Specifically, for example, a treatment time of at least about 12 hours in total is required. As a result, there is a problem in throughput.

With regard to a method for manufacturing a photosemiconductor containing a nitride, the inventors of the present disclosure have found the above-mentioned problems, and extensively conducted studies. Resultantly, the inventors of the present disclosure have attained a manufacturing method capable of manufacturing a nitride safely and conveniently with a high throughput under a low-temperature condition by subjecting a metal to a treatment using a plasma of a nitrogen-containing gas. The manufacturing method has an aspect as shown below.

### Outline of One Aspect According to the Present Disclosure

A method for manufacturing a photosemiconductor according to a first aspect of the present disclosure includes treating a metal base material containing at least one kind of transition metal with a plasma under a pressure lower than atmospheric pressure and at a temperature lower than a volatilization temperature of the transition metal under an atmosphere at the pressure to provide the photosemiconductor containing the transition metal and a nitrogen element from at least a part of the metal base material,

wherein the plasma is generated by applying a high-frequency voltage at a frequency in a range of not less than 30 MHz and not more than 300 MHz to a gas between a first electrode and a second electrode, and

the gas is any one of:

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

In the method for manufacturing a photosemiconductor according to the first aspect, a metal base material containing a transition metal is subjected to a treatment with a plasma of a nitrogen-containing gas which is generated at a frequency in a VHF range (i.e. not less than 30 MHz and not more than 300 MHz) under a pressure lower than atmospheric pressure. Accordingly, a photosemiconductor containing a transition metal and a nitrogen element is prepared from at least a part of the metal base material, e.g. a metal corresponding to a thickness part extending from a surface of the metal base material to a predetermined depth. Thus, with the method according to the first aspect of the present disclosure, a photosemiconductor containing a transition metal and a nitrogen element can be prepared directly on a metal base material containing a transition metal. That is, when a photosemiconductor is manufactured by the method according to the first aspect, the throughput is improved because a photosemiconductor can be formed directly on a metal base material without forming a precursor such as an oxide. With the method according to the first aspect, a structure having a photosemiconductor disposed on a metal base material can be manufactured through a simple step. Further, the resulting structure can attain excellent adhesion between the metal base material and the photosemiconductor.

Further, in the treatment with a plasma in the method according to the first aspect, nitrogen is diffused in the depth direction of a metal base material from a surface of the base material. Thus, a nitrogen-containing photosemiconductor can be formed with the nitrogen concentration continuously changed along the depth direction of the base material. Accordingly, a boundary portion between the photosemiconductor and the metal base material serves as a buffer layer, so that occurrence of cracking or film peeling, which is caused by a difference in thermal expansion coefficient between the base material and the film when a precursor is deposited, and a photosemiconductor is formed through a heat treatment process such as an ammonia gas reduction-nitriding method, can be suppressed.

By using a plasma generated at a frequency in a VHF range in a treatment with a plasma, a plasma density in the plasma treatment can be increased, i.e. chemically very active radical ion species (excited species) can be grown. Specifically, the plasma density increases in proportion to a square of a power frequency when a pressure and a volume are constant. A chemical reaction rate increases as a number of particles that collide per unit time becomes larger. In other words, as a concentration of substances that contribute to the reaction increases, a collision probability of reactants becomes higher, and therefore the chemical reaction rate increases. Thus, an increase in plasma density makes it possible to increase a chemical reaction rate. Here, the plasma density refers to an ion density and electron density at which positively charged ions, negatively charged electrons and neutral particles existing in a plasma reach an equilibrium state after being repeatedly excited, ionized and recombined.

When a plasma generated at a frequency in a VHF range is used, kinetic energy of charged particles decreases because a collision frequency of atoms and molecules in the plasma is high, and further, a difference between a plasma potential and a base material surface potential, i.e. a sheath potential decreases, so that a self bias voltage can be reduced. Accordingly, influences of ion impact can be suppressed, so that deterioration of quality of a surface of a photosemiconductor, i.e. generation of defects can be suppressed. Here, the self bias voltage is as follows. In a plasma generated by use of a high frequency, a high-frequency current is fed through an electrode to change a direction of an electric field in a very short period. At this time, ions existing in the plasma and having a relatively large mass cannot follow the electric field change, while electrons in the plasma follow an external electric field to reach the electrode at a high speed, and are negatively charged. As a result, a direct-current negative bias voltage, i.e. a self bias voltage is generated near the electrode. By an electric field resulting from a self bias of the electrode, ions are accelerated to collide against the electrode having a negative bias potential, and give ion impact. This is one of factors of generating defects.

The gas is any one of the items (i) to (iv). Since the gas does not contain hydrogen, ammonia is not generated. Accordingly, the reaction of formula (B) does not take place, and therefore reduction of reaction efficiency can be avoided. Further, since the gas does not contain water, the reaction of formula (C) does not take place. Thus, reduction of reaction efficiency can be avoided.

As described above, with the method for manufacturing a photosemiconductor according to the first aspect, a photosemiconductor can be manufactured in a shorter time as compared to a conventional manufacturing method using an ammonia gas reduction nitriding method, and as a result, a throughput can be improved. In the method for manufacturing a photosemiconductor according to the first aspect, safety is secured because use of an ammonia gas is not essential, and convenience is improved because installation of a damage elimination apparatus etc., is not required. In the method for manufacturing a photosemiconductor according to the first aspect, manufacturing costs of a photosemiconductor can be reduced due to improvement of the throughput and convenience, etc. The photosemiconductor obtained by the manufacturing method according to the first aspect contains at least a nitrogen element and at least one kind of transition metal in a crystal structure. Accordingly, a photosemiconductor capable of widening a wavelength range over which a reaction with light takes place can be obtained. Specifically, the valence band in a nitride photosemiconductor is positioned at a higher level as compared to the valence band in an oxide photosemiconductor, and therefore it is possible to narrow the width of the band gap, i.e. widen a wavelength range over which a reaction with light takes place, so that the photocurrent value can be increased.

In a second aspect, for example, the photosemiconductor may be a visible light-responsive photocatalyst in the manufacturing method according to the first aspect.

In the manufacturing method according to the second aspect, a photosemiconductor serving as a visible light-responsive photocatalyst can be manufactured safely and conveniently with a high throughput.

In a third aspect, for example, the gas may be any one of (ii) a gaseous mixture consisting of a nitrogen gas and an oxygen gas and (iv) a gaseous mixture of a nitrogen gas, an oxygen gas and a rare gas, the oxygen gas having a partial pressure of not more than 0.1%, in the manufacturing method according to the first aspect.

In the manufacturing method according to the third aspect, a nitriding reaction rate can be controlled, and therefore a throughput for preparation of a photosemiconductor is improved. Specifically, when a plasma treatment is performed with a gas containing only nitrogen, metal ions among constituent ions of a compound may be reduced to secure stability. When oxygen exists in a plasma gas, a reduction reaction can be suppressed, but if an amount of oxygen exceeds a certain amount, a nitriding reaction may hardly proceed because oxygen has an electronegativity larger than that of nitrogen, and free energy of formation of an oxide is relatively stable as compared to free energy of formation of a nitride, so that an oxidation reaction rate exceeds a nitriding reaction rate, i.e. a reverse reaction is dominant. In contrast, when a gas with oxygen constituting not more than 0.1% of a total pressure is used, the nitriding reaction rate exceeds the reverse reaction rate, i.e. the oxidation reaction rate, so that the nitriding reaction can be made to slowly proceed as a whole, i.e. the nitriding reaction can be properly controlled.

In a fourth aspect, for example, the transition metal may be at least one selected from transition metals of Groups 11 and 12 in the manufacturing method according to the first aspect.

In a fifth aspect, for example, the photosemiconductor may be a copper-containing nitride or a zinc-containing nitride in the manufacturing method according to the first aspect.

Metal ions of copper (I) and zinc (II) are expected to have an orbit at a level of a valence band in a photosemiconductor. Thus, when the photosemiconductor is a copper-containing nitride or a zinc-containing nitride, the valence band in the photosemiconductor has increased band dispersion and a reduced hole effective mass, so that the mobility of holes is improved to increase the width of a depletion layer. As a result, the probability of recombination of electrons and holes in the photosemiconductor decreases, so that oxidation reaction of water more easily proceeds. Thus, the photosemiconductor obtained by the method according to the fifth aspect makes it possible to ensure that oxidation reaction of water easily proceeds.

In a sixth aspect, for example, surfaces of the first and second electrodes may be formed of metal in the manufacturing method according to the first aspect.

In the manufacturing method of the present disclosure, there is a wide selection of electrode materials for a plasma generating apparatus because ammonia is not used. As a result, an electrode formed of metal can be used for a long period of time.

In a seventh aspect, for example, surfaces of the first and second electrodes may be formed of stainless steel (hereinafter, referred to as “SUS”) in the manufacturing method according to the sixth aspect.

In a manufacturing method according to the seventh aspect, an electrode holding a base material (hereinafter, referred to as a “holding electrode”) in a plasma generating apparatus to be used in a treatment with a plasma is formed of SUS, which is a material that hardly captures oxygen. Accordingly, oxygen is hardly captured by the holding electrode, and further, deviation of a plasma composition distribution due to release of captured oxygen hardly occurs. Accordingly, stability of a treatment with a plasma is improved, and as a result, stability of manufacturing of a photosemiconductor is improved.

A photosemiconductor according to an eighth aspect of the present disclosure includes: a substrate; and a photosemiconductor layer, wherein the photosemiconductor layer is formed on a front surface of the substrate, the photosemiconductor layer contains nitrogen, and at least one kind of transition metal, a ratio of the transition metal to the nitrogen is smaller on a front surface of the photosemiconductor layer than on a back surface of the photosemiconductor layer, and the substrate contains a transition metal identical to the transition metal contained in the photosemiconductor layer.

In the photosemiconductor according to the eighth aspect, the surface of the photosemiconductor layer is a main surface (i.e., second main surface) on a side opposite to a main surface (i.e., first main surface) situated closer to a base material side, among two main surfaces of the photosemiconductor layer. Thus, when the photosemiconductor according to the eighth aspect has a configuration in which other layer is not provided on the photosemiconductor layer, an exposed surface of the photosemiconductor layer corresponds to the “surface of the photosemiconductor layer”, and when the photosemiconductor according to the eighth aspect has a configuration in which some other layer is provided on the photosemiconductor layer, an interface between the photosemiconductor layer and the other layer corresponds to the “surface of the photosemiconductor layer”. In the photosemiconductor layer in the photosemiconductor according to the eighth aspect, a region on a base material side with respect to a center plane of the photosemiconductor layer in a thickness direction is defined as a “base material side of the photosemiconductor layer”, and a region opposite to the “base material side of the photosemiconductor layer” is defined as a “surface side of the photosemiconductor layer”.

In the photosemiconductor according to the eighth aspect, the photosemiconductor layer contains compounds having mutually different ratios of oxygen to nitrogen on the surface side and on the base material side. In other words, the photosemiconductor layer can be considered as being formed of mutually different semiconductor materials on the surface side and on the base material side, and the photosemiconductor layer itself can serve as a layer which easily separates charges. Thus, electrons and holes generated in the photosemiconductor layer by photoirradiation are hardly recombined in the photosemiconductor layer, and easily move to positions at which reactions involving these electrons and holes take place, respectively. Thus, the photosemiconductor according to the eighth aspect can exhibit excellent charge separation property.

In a ninth aspect, for example, the photosemiconductor according to the eighth aspect may be a visible light-responsive photocatalyst.

According to the ninth aspect, a photosemiconductor serving as a visible light-responsive photocatalyst can be provided.

A hydrogen production device according to a tenth aspect of the present disclosure includes: a photosemiconductor according to the ninth aspect; an electrolyte solution; and a housing containing the photosemiconductor and the electrolyte solution.

In the hydrogen production device according to the tenth aspect, the photosemiconductor according to the ninth aspect is used as a photocatalyst, and thus hydrogen generation efficiency in a water-splitting reaction can be improved.

### EXEMPLARY EMBODIMENTS

### First Exemplary Embodiment

Hereinafter, a method for manufacturing a photosemiconductor according to one exemplary embodiment of the present disclosure will be described with reference to drawings. In the drawings, respective constituent elements are schematically shown for easy understanding, and shapes etc. are not correctly depicted. Values, materials, constituent elements, positions of constituent elements, and so on, which are shown in the following exemplary embodiment, are illustrative, and are not intended to limit the method for manufacturing a photosemiconductor according to the present disclosure. Among constituent elements in the following exemplary embodiment, constituent elements which are not described in the manufacturing method according to the first aspect which is a highest-order concept of the present disclosure will be described as optional constituent elements that form a more preferred configuration.

A method for manufacturing a photosemiconductor according to the present exemplary embodiment includes treating a metal base material containing at least one kind of transition metal with a plasma under a pressure lower than atmospheric pressure and at a temperature lower than a volatilization temperature of the transition metal under an atmosphere at the pressure to provide the photosemiconductor containing the transition metal and a nitrogen element from at least a part of the metal base material,

wherein the plasma is generated by applying a high-frequency voltage at a frequency in a range of not less than 30 MHz and not more than 300 MHz to a gas between a first electrode and a second electrode, and

the gas is any one of:

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

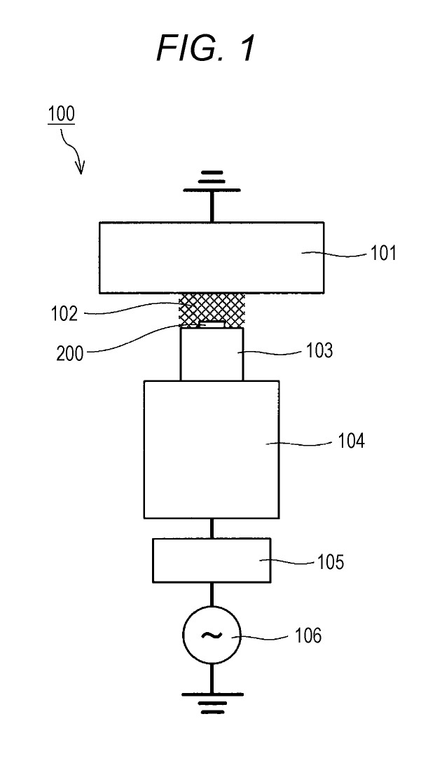

First, one example of a plasma generating apparatus usable in a plasma treatment in the manufacturing method according to the present exemplary embodiment will be described with reference to FIG. 1.

FIG. 1 is a schematic view showing an example of a configuration of the plasma generating apparatus. Plasma generating apparatus 100 includes upper electrode 101 connected to ground; lower electrode (i.e., holding electrode) 103 also serving as a stage on which a plasma treatment object is set; heater 104 installed below lower electrode 103; matching unit 105 installed below the heater; and high-frequency power source 106. In FIG. 1, reference numeral 102 denotes a plasma. FIG. 1 shows a state in which as a plasma treatment object, metal base material 200 before plasma treatment is set on apparatus 100.

A kind of the plasma is not particularly limited, but it is desirable to use a non-thermal equilibrium plasma generated by glow discharge. A thermal equilibrium plasma generated by arc discharge may also be used.

For generation of the plasma, various kinds of methods and means such as, for example, an inductively coupled plasma method, a microwave plasma method, and electrode methods such as those of parallel-plate type and coaxial type can be used.

As a power source for generating a plasma, a high-frequency power source in a VHF range is used. By using a plasma in a VHF range, a high plasma density can be achieved, so that a chemical reaction rate can be increased, i.e. a chemical reaction can be accelerated. Thus, a VHF power source is used as high-frequency power source 106 in plasma generating apparatus 100 shown in FIG. 1.

High-frequency power source 106 may be installed on an upper electrode 101 side rather than being installed below heater 104 as in plasma generating apparatus 100 shown in FIG. 1.

For upper electrode 101 and lower electrode 103, various metals such as niobium (Nb), tantalum (Ta), aluminum (Al), titanium (Ti), silver (Ag), copper (Cu), silicon (Si), gold (Au), platinum (Pt) and SUS can be used. Since upper electrode 101 and lower electrode 103 are exposed to a plasma, it is preferred that a metal having low corrosiveness, i.e. low reactivity is used for these electrodes. Accordingly, a gas is selectively consumed in upper electrode 101 and lower electrode 103, i.e. a reaction of the gas with the electrode can be prevented from proceeding. The consumed gas component can be prevented from being secondarily volatilized and generated from upper electrode 101 and lower electrode 103 in the treatment. Accordingly, stability of the treatment can be secured without causing deviation of a plasma composition distribution.

For suppressing occurrence of deviation of a plasma composition distribution to improve stability of the plasma treatment, it is preferred that a material which hardly captures oxygen is used for lower electrode 103 that holds a plasma treatment object. The material which hardly captures oxygen is, for example, SUS. Accordingly, oxygen is hardly captured by lower electrode 103, and further, deviation of a plasma composition distribution due to release of captured oxygen hardly occurs, so that stability of a treatment with a plasma is improved, and as a result, stability of manufacturing of a photosemiconductor is improved.

A material (e.g., Nb) which easily captures oxygen may be used for lower electrode 103. When such a material is used, the electrode captures a part of oxygen in a gas to reduce an oxygen partial pressure of the gas, even if the oxygen partial pressure of the gas used in the plasma treatment is somewhat high. Therefore, it is not necessary to perform control under a condition for limiting the oxygen partial pressure in the gas to a very low level, and it becomes easy to manufacture a photosemiconductor.

A film which is provided on a surface of a conventional member by, for example, a plasma etching apparatus and which has high plasma resistance and corrosion resistance may be formed on each of upper electrode 101 and lower electrode 103. As materials of the film, yttrium oxide (Y₂O₃) and aluminum oxide (Al₂O₃) are known. These films have an effect of suppressing generation of a reaction product due to influences of oxidation and nitriding of electrode members, and an effect of preventing damage to the members by the plasma. Accordingly, a stable plasma treatment can be performed.

A film formed of, for example, a nitride may be formed on each of upper electrode 101 and lower electrode 103. Examples of the material of the film include titanium nitride (TiN), tantalum nitride (TaN) and silicon nitride (SiN). The film is hardly chemically changed by nitrogen, namely, the film is stable. Thus, by using the film in use of a nitrogen plasma, an oxygen source from an electrode member can be significantly reduced, and therefore stable plasma treatment can be performed.

One example of a method for manufacturing a photosemiconductor by use of the above-mentioned plasma generating apparatus will now be described.

The photosemiconductor manufactured in the present exemplary embodiment is a photosemiconductor which includes a compound containing nitrogen and at least one kind of transition metal in a crystal structure. The transition metal in the compound may be, for example, at least one selected from transition metals of Groups 11 and 12, and examples of the transition metal include copper and zinc. Here, as examples, a first example in which the transition metal is copper, and a copper nitride (composition: CuₓN_{y}) is manufactured as a photosemiconductor with copper metal used as a starting material, and a second example in which the transition metal is zinc, and a zinc nitride (composition: Zn_{α}N_{β}) is manufactured with zinc metal used as a starting material will be described. It is preferable that the copper nitride (composition: CuₓN_{y}) manufactured in the first example ideally satisfies a relationship of x=3 and y=1 (i.e., x:y=3:1). That is, the copper nitride manufactured in the first example is preferably copper nitride (I). NPL 5 discloses that copper nitride represented by the composition formula Cu₃N can be used as a photosemiconductor. It is preferable that the zinc nitride (composition: Zn_{α}N_{β}) manufactured in the second example ideally satisfies a relationship of α=3 and β=2 (i.e., α:β=3:2). That is, the zinc nitride manufactured in the second example is preferably zinc nitride (II). However, when the photosemiconductor is a photocatalyst which can respond to visible light, and maintains a crystal structure, the composition may be deviated.

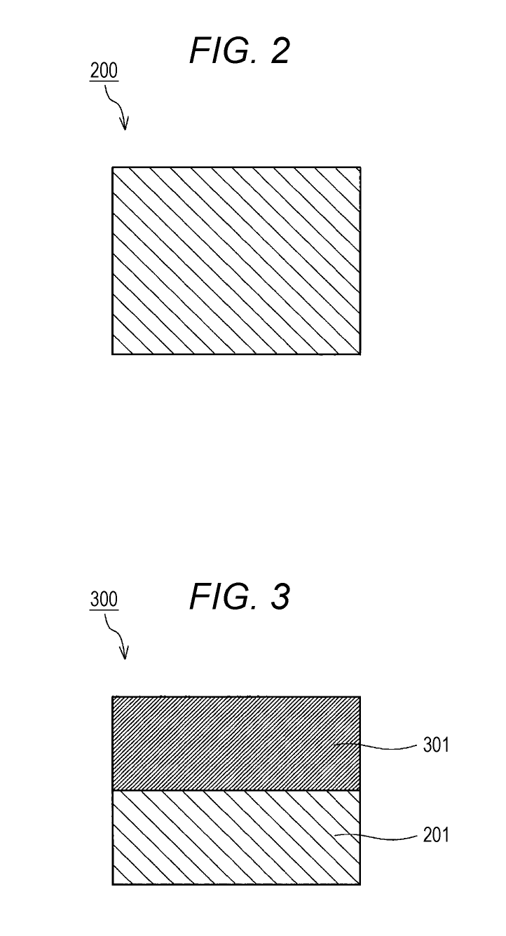

FIGS. 2 and 3 are sectional views showing examples of steps in the method for manufacturing a photosemiconductor according to the present exemplary embodiment. Specifically, FIG. 2 is a sectional view showing a metal base material as a starting material for a photosemiconductor. In other words, FIG. 2 is a sectional view of the metal base material before plasma treatment. FIG. 3 is a sectional view showing a state in which a metal base material is subjected to plasma treatment. In other words, FIG. 3 is a sectional view showing a photosemiconductor in which a photosemiconductor layer has been formed on the metal base material.

First, metal base material 200 containing at least one kind of transition metal as shown in FIG. 2 is prepared.

Next, metal base material 200 containing a transition metal is subjected to plasma treatment in a step as shown in FIG. 3. By an excited nitrogen plasma gas, a transition metal corresponding to a thickness part extending from a surface of metal base material 200 to a predetermined depth is nitrided to form photosemiconductor layer 301. A portion of metal base material 200 which has not been nitrided serves as substrate 201. Accordingly, photosemiconductor 300 including substrate 201 and photosemiconductor layer 301 is obtained.

The plasma treatment in the manufacturing method according to the present exemplary embodiment is a treatment with a high-frequency plasma in a VHF range as described above. The high-frequency plasma in a VHF range is a plasma generated at a frequency in a range of 30 MHz to 300 MHz.

A rotation temperature of a plasma gas in performing plasma treatment may be within a range of from 480 K to 1,100 K (i.e., from 207 degrees Celsius to 827 degrees Celsius). When the rotation temperature of a gas to be used in plasma treatment is in a range of 480 K to 1,100 K, a chemical reaction rate at which a transition metal as a starting material is nitrided can be controlled. Specifically, the chemical reaction rate depends on a reaction rate constant, and the reaction rate constant k is a function dependent on a temperature in accordance with Arrhenius' equation k=Aexp (−Eₐ/RT) (A: frequency factor, Eₐ: activation energy, R: gas constant, temperature: T). Thus, by controlling the temperature, a thickness of a photosemiconductor formed of the resulting nitride can be controlled.

However, some materials (transition metals) contained in metal base material 200 may be volatilized when plasma treatment is performed at a gas temperature above a certain temperature. Thus, plasma treatment is performed at a temperature lower than a volatilization temperature of a transition metal contained in metal base material 200 under a pressure of an atmosphere in which plasma treatment is performed. For example, when the transition metal is copper, and plasma treatment is performed at a pressure almost equal to atmospheric pressure (note that the pressure is lower than atmospheric pressure), the temperature is in a range below 1,516 K (i.e., 1,243 degrees Celsius), which is equal to or lower than a volatilization temperature of copper metal at an atmospheric pressure. For example, when the transition metal is zinc, and plasma treatment is performed at a pressure almost equal to atmospheric pressure (note that the pressure is lower than atmospheric pressure), the temperature in plasma treatment is in a range below 616 K (i.e., 343 degrees Celsius), which is equal to or lower than a volatilization temperature of zinc metal at an atmospheric pressure.

The “rotation temperature” will now be described. The “rotation temperature” is an index showing a magnitude of rotational energy in a degree of freedom of a molecule around a center of gravity of an atomic nucleus. The rotation temperature is in equilibrium with a translation temperature, i.e. a kinetic temperature due to collision with neutral molecules and exited molecules in a pressure range near atmospheric pressure. Thus, the rotation temperature of a N₂ molecule can be generally considered as a gas temperature. Thus, the gas temperature can be determined by analyzing light emission of a nitrogen plasma, and measuring the rotation temperature. Specifically, the rotation temperature of the N₂ molecule can be calculated by, for example, analyzing a light emission spectrum generated in electron transition from a C³Πᵤ level to B³Π_{g} level, the light emission spectrum being called a 2nd positive system that is one light emission spectrum belonging to a light emission spectrum group of the N₂ molecule. The electron transition is caused by transition from a rotational level in various vibrational levels within a certain electron level to a rotational level or a vibrational level in other electron level. Assuming that electrons existing at the rotational level in the C³Πᵤ level and the B³Π_{g} level are Boltzmann-distributed, a light emission spectrum in a certain vibrational level depends on the rotation temperature. Accordingly, the rotation temperature of the N₂ molecule can be determined by comparing a measured spectrum with a calculated spectrum calculated from a theoretical value. The rotation temperature can be determined by, for example, measuring a light emission spectrum (0,2) band of N₂ which is observed near a wavelength of 380.4 nm. The (0,2) band is a vibrational band in electron transition, and indicates that a vibrational quantum number at the C³Πᵤ level being an upper level is 0, and the vibrational quantum number at the B³Π_{g} level being a lower level is 2. Specifically, a distribution of light emission intensities in a certain vibrational band depends on the rotation temperature. For example, a relative intensity on a shorter wavelength side from a wavelength of 380.4 nm increases as the rotation temperature rises.

The rotation temperature of a plasma gas can be measured by emission-spectrometry (see NPL 4). As a measurement device, for example, a plasma measurement system manufactured by NU System Inc. may be used, or the rotation temperature may be calculated by fitting of results of emission-spectrometry using a plasma emission spectrometer manufactured by Hamamatsu Photonics K.K.

A temperature is not required to be applied to lower electrode 103 (see FIG. 1). The temperature on the lower electrode 103 side is expected to have an effect of enhancing diffusion of nitrogen, and a sufficient nitriding ability is exhibited only with a plasma gas temperature. Here, a nitriding treatment can be performed without applying a temperature to lower electrode 103, and apparatus 100 can be simplified.

With regard to the plasma gas, the nitriding ability varies according to, for example, a partial pressure ratio of nitrogen and oxygen, and a relationship between plasma treatment conditions and a nitriding degree is not limited to the relationship described above. A range of each of preferred plasma treatment conditions can be appropriately selected according to, for example, a partial pressure ratio of nitrogen and oxygen in the plasma gas. The nitriding ability also varies depending on magnitudes of the electrode area, the power and so on, and therefore the electrode area and the power are not limited to the conditions described above.

Preferably, the plasma treatment is performed by use of a gas containing nitrogen and having an oxygen partial pressure of not more than 0.1% of the total pressure.

The plasma gas is any one of

(i) a nitrogen gas;

(ii) a gaseous mixture consisting of a nitrogen gas and an oxygen gas;

(iii) a gaseous mixture consisting of a nitrogen gas and a rare gas; and

(iv) a gaseous mixture consisting of a nitrogen gas, an oxygen gas, and a rare gas.

The electric power (power density) per area in plasma treatment may be, for example, 88 W/cm² to 808 W/cm². When the power density during plasma treatment is excessively high, the temperature of a plasma gas may be elevated to exceed the volatilization temperature of a transition metal, i.e. the temperature during plasma treatment may exceed the volatilization temperature of the transition metal. Thus, it is preferable that the power density during plasma treatment is, for example, 200 W/cm² or less for making it easy to perform plasma treatment at a temperature lower than the volatilization temperature of a transition metal contained in the metal base material.

With the manufacturing method of the present exemplary embodiment, a photosemiconductor can be manufactured in which a photosemiconductor layer including a compound containing nitrogen and at least one kind of transition metal (e.g. zinc and/or copper) in a crystal structure is provided on a metal base material (substrate) containing a transition metal. With the manufacturing method of the present exemplary embodiment, for example, a photosemiconductor layer can be manufactured in which a ratio of a transition metal to nitrogen in the crystal structure of the compound is larger on a base material side of the photosemiconductor layer than a surface side of the photosemiconductor layer. Such a photosemiconductor layer itself can serve as a layer which easily separates charges, and therefore electrons and holes generated in the photosemiconductor layer by, for example, photoirradiation are hardly recombined. Thus, a photosemiconductor provided with such a photosemiconductor layer can exhibit excellent charge separation property.

With the manufacturing method of the present exemplary embodiment, for example, a photosemiconductor layer can also be prepared which has a configuration in which the ratio of a transition metal to nitrogen in the crystal structure of the compound continuously increases from a surface of the photosemiconductor layer toward the base material side. With a photosemiconductor layer having a configuration in which the ratio of a transition metal to nitrogen in the crystal structure continuously increases as described above, a photosemiconductor having improved charge separation property can be provided.

Further, nitrogen is diffused in the depth direction of a transition metal-containing metal base material from a surface of the base material. Thus, a nitrogen-containing photosemiconductor can be formed with the nitrogen concentration continuously changed along the depth direction of the base material. Accordingly, a boundary portion between the photosemiconductor and the metal base material serves as a buffer layer, so that occurrence of cracking or film peeling, which is caused by a difference in thermal expansion coefficient between the base material and the film when a precursor is deposited, and a photosemiconductor is formed through a heat treatment process such as an ammonia gas reduction-nitriding method, can be suppressed.

### Second Exemplary Embodiment

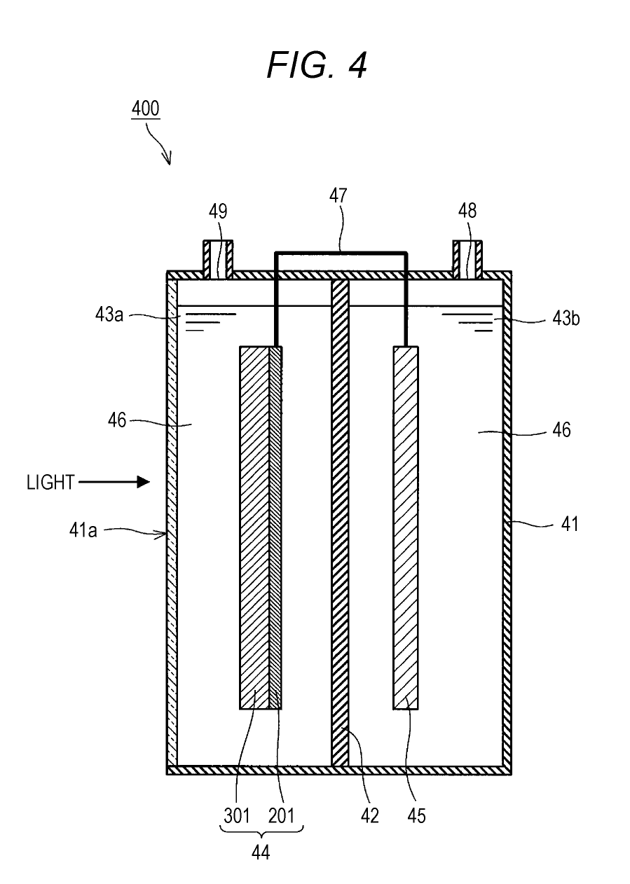

A hydrogen production device according to a second exemplary embodiment of the present disclosure will be described with reference to FIG. 4. FIG. 4 is a schematic view showing one example of a configuration of a hydrogen production device according to the present exemplary embodiment.

Hydrogen production device 400 shown in FIG. 4 includes: housing 41; separator 42 which separates an internal space of housing 41 into first space 43a and second space 43b; water-splitting electrode 44 disposed in first space 43a; counter electrode 45 disposed in second space 43b; and electrolyte solution 46 containing water in first space 43a and second space 43b. Water-splitting electrode 44 and counter electrode 45 are electrically connected to each other with electrical connector 47. Hydrogen production device 400 is further provided with hydrogen gas outlet 48 extending through housing 41 and communicating with an inner part of one of first space 43a and second space 43b that is on a hydrogen generation side (inner part of second space 43b in an example shown in FIG. 4). As necessary, hydrogen production device 400 may be provided with oxygen gas outlet 49 extending through housing 41 and communicating with an inner part of one of first space 43a and second space 43b that is on an oxygen generation side (inner part of first space 43a in an example shown in FIG. 4).

Components of hydrogen production device 400 will now be described in detail.

Housing 41 has light-transmitting surface 41a facing first space 43a. Light-transmitting surface 41a is a surface (i.e., photoirradiation surface) of housing 41 which is irradiated with light. Preferably, light-transmitting surface 41a is formed of a material which has corrosion resistance and insulation quality to electrolyte solution 46. Visible light travels through the material of light-transmitting surface 41a. More preferably, not only light having a wavelength in a visible light range but also light having a wavelength around the visible light range travels through the material of the light-transmitting surface 41. Examples of the material include glass and resin. A part of housing 41 other than light-transmitting surface 41a is only required to have corrosion resistance and insulation quality to electrolyte solution 46, and is not required to have light permeability. For the part of housing 41 other than light-transmitting surface 41a, not only the glass and resin but also metal having a surface subjected to processing for imparting corrosion resistance and insulation can be used.

As described above, separator 42 separates the inner part of housing 41 into first space 43a containing water-splitting electrode 44 and second space 43b containing counter electrode 45. Preferably, separator 42 is disposed so as to be substantially parallel to light-transmitting surface 41a which is the photoirradiation surface of housing 41 as shown in, for example, FIG. 4. Separator 42 plays a role of exchanging ions between electrolyte solution 46 in first space 43a and electrolyte solution 46 in second space 43b. Accordingly, at least a part of separator 42 is in contact with electrolyte solution 46 in first space 43a and in second space 43b. Separator 42 is formed of a material which is permeable to an electrolyte in electrolyte solution 46 and which serves to suppress permeation of an oxygen gas and a hydrogen gas in electrolyte solution 46. A material of separator 42 is, for example, a solid electrolyte such as a high-molecular solid electrolyte. Examples of the high-molecular solid electrolyte include ion exchange membranes such as Nafion (registered trademark). Since the space on the oxygen generation side and the space on the hydrogen generation side in the housing are separated by separator 42, generated oxygen and hydrogen can be collected separately from each other.

Water-splitting electrode 44 is photosemiconductor 300 (see FIG. 3) obtained by the manufacturing method described in the first exemplary embodiment. Thus, water-splitting electrode 44 includes metal base material (substrate) 201, and photosemiconductor layer 301 disposed on base material 201. In the present exemplary embodiment, photosemiconductor 300 is used as an electrode for a device, and therefore base material 201 is a metal base material containing a transition metal, and has electrical conductivity as described in the first exemplary embodiment.

Photosemiconductor layer 301 provided on base material 201 is not necessarily required to be a single-phase semiconductor, and may be a composite composed of a plurality of semiconductors, or may carry a metal etc. serving as a co-catalyst. A mechanism capable of applying a bias voltage may be provided between photosemiconductor layer 301 and counter electrode 45.

For counter electrode 45, a material active to a hydrogen generation reaction is used when a photosemiconductor having electrical conductivity and forming photosemiconductor layer 301 of water-splitting electrode 44 is an n-type semiconductor, and a material active to an oxygen generation reaction is used when the photosemiconductor is a p-type semiconductor. Examples of the material of counter electrode 45 include carbon and noble metals which are generally used in electrodes for electrolysis of water. Specifically, carbon, platinum, platinum-carried carbon, palladium, iridium, ruthenium, or nickel can be employed. A shape of counter electrode 45 is not particularly limited, and an installation position of counter electrode 45 is not particularly limited as long as it is installed in second space 43b. Counter electrode 45 and an inner wall of second space 43b may be in contact with each other, or at a distance from each other.

For electrical connector 47, for example, a general metallic conducting wire can be used.

Electrolyte solution 46 contained in first space 43a and second space 43b may be an electrolyte solution which contains water and in which an electrolyte is dissolved, and electrolyte solution 46 may be acidic, neutral or basic. Examples of the electrolyte include hydrochloric acid, sulfuric acid, nitric acid, potassium chloride, sodium chloride, potassium sulfate, sodium sulfate, sodium hydrogen carbonate, sodium hydroxide, phosphoric acid, sodium dihydrogen phosphate, disodium hydrogen phosphate and sodium phosphate. Electrolyte solution 46 may contain a plurality of the electrolytes.

Operations of hydrogen production device 400 will now be described where the photosemiconductor contained in photosemiconductor layer 301 is an n-type semiconductor, i.e. oxygen is generated from water-splitting electrode 44.

In hydrogen production device 400, light passing through light-transmitting surface 41a of housing 41 and electrolyte solution 46 in first space 43a is incident to photosemiconductor layer 301 of water-splitting electrode 44. Photosemiconductor layer 301 absorbs light to cause photo-excitation of electrons, so that in photosemiconductor layer 301, electrons are generated in a conduction band, and holes are generated in a valence band. Holes generated by photoirradiation move to a surface of photosemiconductor layer 301 (i.e., interface with electrolyte solution 46). The holes oxidize water molecules at the surface of photosemiconductor layer 301, resulting in generation of oxygen (see reaction formula (D) described below). Electrons generated in the conduction band move to base material 201, and move an electrically conductive part of base material 201 to counter electrode 45 through electrical connector 47. The electrons move through an inner part of counter electrode 45 to arrive at a surface of counter electrode 45 (i.e., interface with electrolyte solution 46), and reduce protons at the surface of counter electrode 45, resulting in generation of hydrogen (see reaction formula (E) described below).

4h⁺+2H₂O→O₂↑+4H⁺ (D)

4e⁻+4H⁺→2H₂↑ (E)

The hydrogen gas generated in second space 43b is collected through hydrogen gas outlet 48 communicating with the inner part of second space 43b.

Hydrogen production device 400 of the present exemplary embodiment has been described by showing as an example a case where the photosemiconductor forming photosemiconductor layer 301 is an n-type semiconductor, and when the photosemiconductor forming photosemiconductor layer 301 is a p-type semiconductor, operations of hydrogen production device 400 may be described with oxygen and hydrogen replaced by each other in the foregoing operations where the photosemiconductor is formed of an n-type semiconductor.

While the exemplary embodiments of the present disclosure have been described above, the present disclosure is not limited to the exemplary embodiments, and can be refined, changed or modified without departing from a spirit of the present disclosure.

### EXAMPLES

The present disclosure will be described further in detail by way of examples. The following examples are illustrative, and the present disclosure is not limited by the following examples.

### Inventive Example 1

Copper metal was used as metal base material 200 containing a transition metal. A surface of the copper metal was subjected to plasma treatment. The plasma treatment performed in this example was a treatment with a plasma generated at a frequency in a VHF range, and the frequency was 100 MHz. Plasma treatment conditions were as follows: only a nitrogen gas was made to flow at a flow rate of 400 sccm, a temperature of lower electrode 103 was 310 degrees Celsius, a total pressure was 4.0 kPa in plasma ignition and 10.0 kPa in plasma process, a power was 400 W in ignition and 100 W in plasma process, a power density was 156.3 W/cm², a gap width between electrodes was 9.0 millimeters, and a treatment time was 30 minutes. The plasma treatment in this example was performed at a temperature lower than a volatilization temperature of a transition metal contained in the metal base material. Both upper electrode 101 and lower electrode 103 were formed of SUS.

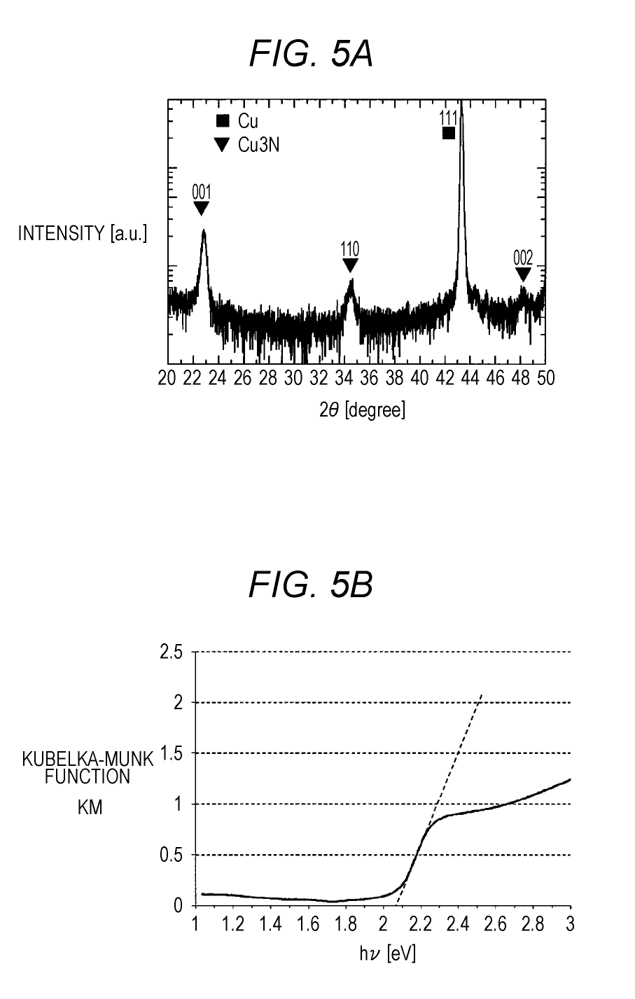

FIG. 5A shows results of X-ray diffraction measurement of a photosemiconductor of this example in which a photosemiconductor layer is formed on copper metal. In X-ray diffraction, only a peak derived from copper nitride (Cu₃N) and a peak derived from copper metal were clearly observed, and thus it was apparent that in this example, copper nitride (Cu₃N) was synthesized on the copper metal. In X-ray diffraction, a CuKα ray having a wavelength of 0.15418 nanometers was used as an X-ray source.

FIG. 5B shows results of ultraviolet/visible diffusion reflection measurement of the photosemiconductor of this example in which a photosemiconductor layer is formed on copper metal. In this measurement, diffusion reflection measurement was performed by use of an integrating sphere. The measurement results were analyzed by use of a Kubelka-Munk function. In the photosemiconductor of this example, an absorption end was observed near a band gap of 2.1 eV. It was also apparent from the ultraviolet/visible diffusion reflection measurement that copper nitride (Cu₃N) was synthesized on the copper metal.

### Inventive Example 2

Zinc metal was used as metal base material 200 containing a transition metal. A surface of the zinc metal was subjected to plasma treatment. The plasma treatment performed in this example was a treatment with a plasma generated at a frequency in a VHF range, and the frequency was 100 MHz. Plasma treatment conditions were as follows: only a nitrogen gas was made to flow at a flow rate of 400 sccm, and a temperature of lower electrode 103 was not elevated. A total pressure was 2.03 kPa in each of plasma ignition and plasma process, a power was 250 W in ignition and 103 W in plasma process, a power density was 160.9 W/cm², a gap width between electrodes was 9.68 millimeters in each of ignition and process, and a treatment time was 60 minutes. A temperature was 20 degrees Celsius at a start of plasma treatment, and 109 degrees Celsius after the treatment. The temperature here was a temperature measured by use of a thermocouple mounted under the lower electrode. The plasma treatment in this example was performed at a temperature lower than a volatilization temperature of a transition metal contained in the metal base material. Upper electrode 101 was formed of Si, and lower electrode 103 was formed of SUS.

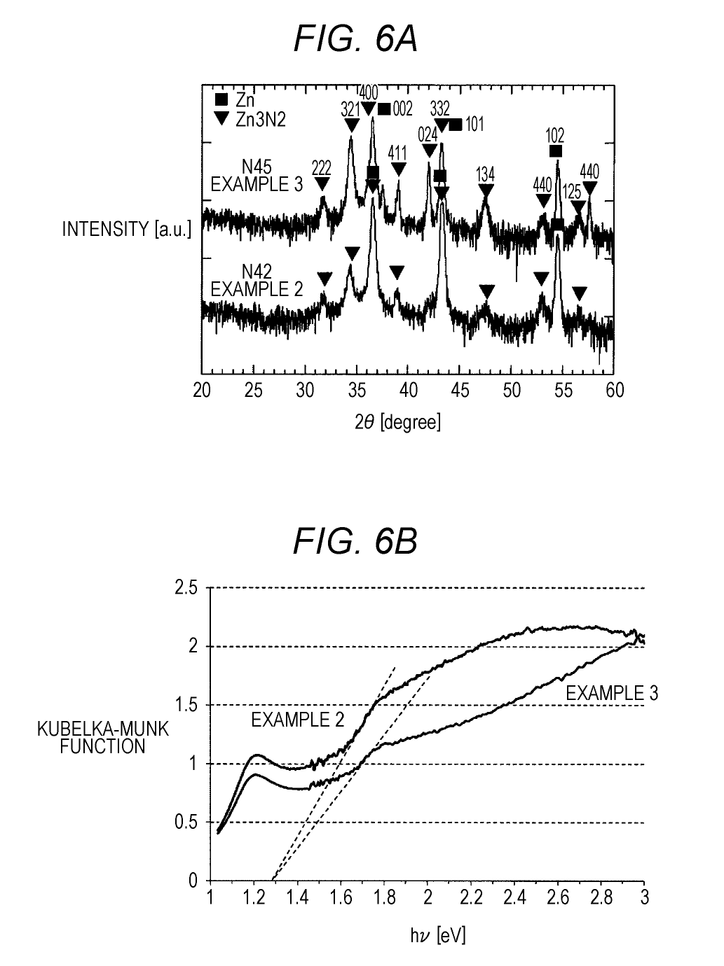

FIG. 6A shows results of X-ray diffraction measurement of a photosemiconductor of this example in which a photosemiconductor layer is formed on zinc metal. In X-ray diffraction, only a peak derived from zinc nitride (Zn₃N₂) and a peak derived from zinc metal were clearly observed, and thus it was apparent that in this example, zinc nitride (Zn₃N₂) was synthesized on the zinc metal.

FIG. 6B shows results of ultraviolet/visible diffusion reflection measurement of the photosemiconductor of this example in which a photosemiconductor layer is formed on zinc metal. In this measurement, diffusion reflection measurement was performed by use of an integrating sphere. The measurement results were analyzed by use of a Kubelka-Munk function. In the photosemiconductor of this example, an absorption end was observed near a band gap of 1.3 eV. It was also apparent from the ultraviolet/visible diffusion reflection measurement that zinc nitride (Zn₃N₂) was synthesized on the zinc metal.

### Inventive Example 3

A photosemiconductor of Inventive example 3 in which a photosemiconductor layer was formed on zinc metal was formed by a method identical to that in Inventive example 2, except that plasma treatment conditions were changed. The plasma treatment performed in this example was a treatment with a plasma generated at a frequency in a VHF range, and the frequency was 100 MHz. Plasma treatment conditions were as follows: only a nitrogen gas was made to flow at a flow rate of 400 sccm, and a temperature of lower electrode 103 was not elevated. A total pressure was 2.0 kPa in plasma ignition and 2.1 kPa in plasma process, a power was 250 W in ignition and 102 W in plasma process, a power density was 159.4 W/cm², a gap width between electrodes was 6.0 millimeters in each of ignition and process, and a treatment time was 60 minutes. A temperature was 37 degrees Celsius at a start of plasma treatment, and 109 degrees Celsius after the treatment. The temperature here was a temperature measured by use of a thermocouple mounted under the lower electrode. The plasma treatment in this example was performed at a temperature lower than a volatilization temperature of a transition metal contained in the metal base material. Upper electrode 101 was formed of Si, and lower electrode 103 was formed of SUS.

FIG. 6A shows results of X-ray diffraction measurement of a photosemiconductor of this example in which a photosemiconductor layer is formed on zinc metal. In X-ray diffraction, only a peak derived from zinc nitride (Zn₃N₂) and a peak derived from zinc metal were clearly observed, and thus it was apparent that in this example, zinc nitride (Zn₃N₂) was synthesized on the zinc metal.

FIG. 6B shows results of ultraviolet/visible diffusion reflection measurement of the photosemiconductor of this example in which a photosemiconductor layer is formed on zinc metal. In this measurement, diffusion reflection measurement was performed by use of an integrating sphere. The measurement results were analyzed by use of a Kubelka-Munk function. In the photosemiconductor of this example, an absorption end was observed near a band gap of 1.3 eV. It was also apparent from the ultraviolet/visible diffusion reflection measurement that zinc nitride (Zn₃N₂) was synthesized on the zinc metal.

### Comparative Example 1

A photosemiconductor of Comparative Example 1 in which a photosemiconductor layer was formed on zinc metal was formed by a method identical to that in Inventive example 2, except that plasma treatment conditions were changed. The plasma treatment performed in this comparative example was a treatment with a plasma generated at a frequency in a VHF range, and the frequency was 100 MHz. Plasma treatment conditions were as follows: only a nitrogen gas was made to flow at a flow rate of 400 sccm, a temperature of lower electrode 103 was 300 degrees Celsius, a total pressure was 5.1 kPa in plasma ignition and 10.0 kPa in plasma process, a power was 200 W in ignition and 130 W in plasma process, a power density was 203.1 W/cm², a gap width between electrodes was 6.0 millimeters and 10.0 millimeters in process, and a treatment time was 3 minutes. The temperature applied to lower electrode 103, and elevation of the gas temperature by the power applied in plasma treatment elevated the temperature in plasma treatment. As a result, the plasma treatment in this comparative example was performed at a temperature higher than a volatilization temperature of a transition metal contained in the metal base material. Upper electrode 101 was formed of Si, and lower electrode 103 was formed of SUS. A nitrogen glow plasma was violet when visually observed, but in this comparative example, emission of clearly blue light was observed when the color of the plasma was visually observed. This may be light emission occurring in volatilization of zinc because the sample after treatment was in a deeply scraped state, and zinc metal was deposited on the upper electrode. Thus, under the conditions in this comparative example, zinc was volatilized, so that it was unable to form a photosemiconductor layer on zinc metal.

### Comparative Example 2

A photosemiconductor of Comparative Example 2 in which a photosemiconductor layer was formed on zinc metal was formed by a method identical to that of Inventive Examples 2, except that plasma treatment conditions were changed. The plasma treatment performed in this comparative example was a treatment with a plasma generated at a frequency in a VHF range, and the frequency was 100 MHz. Plasma treatment conditions were as follows: only a nitrogen gas was made to flow at a flow rate of 400 sccm, and a temperature of lower electrode 103 was not elevated. A total pressure was 5.1 kPa in plasma ignition and 8.0 kPa in plasma process, a power was 200 W in ignition and 142 W in plasma process, a power density was 221.9 W/cm², a gap width between electrodes was 6.0 millimeters in ignition and 10.0 millimeters in process, and a treatment time was 15 minutes. A temperature was room temperature at a start of plasma treatment, and 134 degrees Celsius after the treatment. The temperature here was a temperature measured by use of a thermocouple mounted under the lower electrode. In Comparative Example 2, the power density was high, so that the temperature of the lower electrode after plasma treatment was elevated to 134 degrees Celsius. Upper electrode 101 was formed of Si, and lower electrode 103 was formed of SUS. A nitrogen glow plasma was violet when visually observed, but in this comparative example, emission of blue-violet light was observed when the color of the plasma was visually observed. This may be light emission occurring in volatilization of zinc because the sample after treatment was in a deeply scraped state, and zinc metal was deposited on the upper electrode. Thus, under the conditions in this comparative example, zinc was volatilized, so that it was unable to form a photosemiconductor layer on zinc metal.

### INDUSTRIAL APPLICABILITY

The method for manufacturing a photosemiconductor according to the present disclosure can be used as a method for manufacturing a visible light-responsive photocatalyst, and is useful in, for example, photocatalyst related techniques such as devices for producing hydrogen from sunlight.

### REFERENCIAL SIGNS LIST

100 plasma apparatus
101 upper electrode
102 plasma
103 lower electrode (holding electrode)
104 heater
105 matching unit
106 high frequency power source
200 metal base material
201 metal base material (substrate)
300 photosemiconductor
301 photosemiconductor layer
400 hydrogen production device
41 housing
41a light-transmitting surface
42 separator
43a first space
43b second space
44 water-splitting electrode
45 counter electrode
46 electrolyte solution
47 electrical connector
48 hydrogen gas outlet
49 oxygen gas outlet

What is claimed is:

1. A method for manufacturing a photosemiconductor, the method comprising:
treating a metal base material containing at least one kind of transition metal with a plasma under a pressure lower than atmospheric pressure and at a temperature lower than a volatilization temperature of the transition metal under the pressure to provide the photosemiconductor containing the transition metal and a nitrogen element from at least a part of the metal base material,
wherein
the plasma is generated by applying a high-frequency voltage at a frequency in a range of not less than 30 MHz and not more than 300 MHz to a gas between a first electrode and a second electrode; and
the gas is any one of:
(i) a nitrogen gas;
(ii) a gaseous mixture consisting of a nitrogen gas and an oxygen gas;
(iii) a gaseous mixture consisting of a nitrogen gas and a rare gas; and
(iv) a gaseous mixture consisting of a nitrogen gas, an oxygen gas, and a rare gas.

2. The method according to claim 1, wherein
the photosemiconductor is a visible light-responsive photocatalyst.

3. The method according to claim 1, wherein
the gas is any one of:
(ii) a gaseous mixture consisting of a nitrogen gas and an oxygen gas; and
(iv) a gaseous mixture of a nitrogen gas, an oxygen gas, and a rare gas, and
the oxygen gas has a partial pressure of not more than 0.1%.

4. The method according to claim 1, wherein
the transition metal is at least one selected from transition metals of Groups 11 and 12.

5. The method according to claim 1, wherein
the photosemiconductor is a copper-containing nitride or a zinc-containing nitride.

6. The method according to claim 1, wherein
surfaces of the first and second electrodes are formed of metal.

7. The method according to claim 6, wherein
the surfaces of the first and second electrodes are formed of stainless steel.

8. A photosemiconductor comprising:
a substrate; and
a photosemiconductor layer,
wherein
the photosemiconductor layer is formed on a front surface of the substrate;
the photosemiconductor layer contains nitrogen and at least one kind of transition metal;
a ratio of the transition metal to the nitrogen is smaller on a front surface of the photosemiconductor layer than on a back surface of the photosemiconductor layer; and
the substrate contains a transition metal identical to the transition metal contained in the photosemiconductor layer.

9. The photosemiconductor according to claim 8, which is a visible light-responsive photocatalyst.

10. A hydrogen production device comprising:
the photosemiconductor according to claim 9;
an electrolyte solution; and
a housing containing the photosemiconductor and the electrolyte solution.
